(19) United States
(12) Patent Application Publication
(10) Pub. No.: US 2012/0042965 A1
(43) Pub. Date: Feb. 23, 2012

(54) Apparatus and Method for Mounting an Inflator, Exhaust Valve or Relief Valve Interiorly of an Inflatable Article

(75) Inventors: Glenn H. Mackal, South Pasadena, FL (US); John H. Lucius, Safety Harbor, FL (US)

(73) Assignee: Halkey-Roberts Corporation, St. Petersburg, FL (US)

(21) Appl. No.: 13/214,307

(22) Filed: Aug. 22, 2011

Related U.S. Application Data
(60) Provisional application No. 61/375,866, filed on Aug. 22, 2010.

(51) Int. Cl. F16K 51/00

(52) U.S. Cl. 137/343; 29/525.01

(57) ABSTRACT

An apparatus and method for mounting an inflator, exhaust valve or relief valve interiorly of an inflatable article, comprising a receiver having an integral mounting flange formed about its upper periphery that is heat sealed interiorly about an opening in the fabric of an inflatable article to be substantially flush with the contour of the inflatable article once inflated. The receiver comprises a generally circular cylindrical bore for removably receiving a corresponding generally circular cylindrical portion of the inflator, exhaust valve or relief valve therein. A locking key removably engages into corresponding detents in the mounting flange to removably secure the inflator, exhaust valve or relief valve in the bore. An O-ring is provided about the generally circular cylindrical portion of the inflator, exhaust valve or relief valve to form a seal with the bore and prevent any leakage of gas from the interior of the inflatable article.

### CROSS-REFERENCE TO RELATED INVENTIONS

This application claims the benefit of provisional application No. 61/375,866, filed Aug. 22, 2010, the disclosure of which is incorporated herein.

### BACKGROUND OF THE INVENTION

1. Field of the Invention

This invention relates to inflators, exhaust valves and pressure relief valves for inflating, exhausting or pressure-relieving articles, such as personal floatation devices, rafts, buoys, and emergency signaling equipment. More particularly, this invention relates receivers that may be directly heat-sealed to the inflatable article for removably receiving the inflator, exhaust valve or relief valve.

2. Description of the Background Art

Presently there exist many types of inflators, exhaust valves and pressure relief valves designed to inflate, exhaust and pressure relief inflatable articles such as personal floatation devices (life vests, rings and horseshoes), life rafts, buoys and emergency signaling equipment.

Inflators typically comprise a body for receiving the neck of a cartridge of compressed gas such as carbon dioxide. A reciprocating pierce pin is disposed within the body of the inflator for piercing frangible seal of the cartridge to permit compressed gas therein to flow into a manifold assembly of the inflator and then into the article to be inflated. Typically, a manually movable firing lever is operatively connected to the piercing pin such that the piercing pin pierces the frangible seal of the cartridge upon jerking of a ball lanyard. U.S. Pat. No. 3,809,288, the disclosure of which is hereby incorporated by reference herein, illustrates one particular embodiment of a manual inflator.

Water-activated actuators have been incorporated into manual inflators so that in an emergency situation such as downed aviator, injured person or a man overboard, the inflator is automatically actuated to inflate the inflatable article to which it is connected. Representative automatic actuators for inflators are disclosed in U.S. Pat. Nos. 3,059,814, 3,091,782, 3,426,942, 3,579,964, 3,702,014, 3,757,371, 3,910,457, 3,997,079, 4,223,805, 4,267,944, 4,260,075, 4,382,231, 4,436,159, 4,513,248, 4,627,823, and 5,076,468, the disclosures of which are hereby incorporated by reference herein.

Exhaust valves, sometimes also called dump valves, for inflatable articles typically comprise a spring-loaded, normally-closed valve seat having an actuator that may be manually operated to unseat the valve seat against the pressure of the spring thereby “dumping” the air in the inflatable article. Exhaust valves are commonly used in inflatable articles to allow rapid deflation of the article.

Relief valves, sometimes more specifically called pressure relief valves, for inflatable articles typically comprise a spring-loaded, normally-closed check valve having a preset cracking pressure. As the internal pressure inside the inflatable article exceeds the preset cracking pressure, the check valve is forced open, thereby relieving the build-up of pressure in the article. The relief valve then automatically closes once the internal pressure drops below the preset cracking pressure. Pressure relief valves are commonly used in inflatable articles to prevent the article from bursting due to over-pressurization when the inflator fires and the gas is released from the gas cartridge.

Inflators, whether manually or water-activated, are typically connected to exterior of the inflatable article by means of the manifold assembly that consists of a metal manifold having a lower flange which is molded in situ with a rubber flange to establish a flow path between the flange and the metal manifold. A one-way valve, such as a Schrader valve, is installed in the manifold. During installation, a hole is formed in the inflatable article and the manifold is positioned therethrough. The flange of the manifold assembly is then heat-sealed to the fabric of the inflatable article. Notably, the one-way valve in the manifold permits inflation of the inflatable article while precluding deflation once inflated in the event the gas cartridge is removed. Correspondingly, typical inflators comprise a manifold hole which is configured and dimensioned to receive the manifold of the manifold assembly. A locking nut is threaded onto the end of the manifold to secure the inflator. An O-ring seal is provided to prevent leakage between the manifold and the inflator. During use, upon firing of the inflator, either manually or automatically, gas from the compressed gas cartridge flows into the manifold hole of the inflator and then into the manifold. The gas then flows past the one-way valve in the manifold and into the inflatable article. Since the one-way valve of the manifold assembly precludes deflation of the inflatable article, the gas cartridge may be removed from the inflator and the inflatable article will remain inflated. Representative patents relating to manifold assemblies are U.S. Pat. Nos. 5,306,187, 5,080,402, 5,058,933, 5,058,932, 4,216,182, 3,809,288 and 3,754,731, the disclosures of which are hereby incorporated by reference herein.

Inflators having an integral mounting flange that are heat-sealed directly to an inflatable article have been developed. However, similar to inflators that are mounted using an manifold assembly, heat-sealable inflators include a one-way valve to permit inflation of the inflatable article while precluding deflation once inflated in the event the gas cartridge is removed. Representative heat-sealable inflators are disclosed in U.S. Pat. Nos. 4,894,036, 5,564,478 and 7,475,711, the disclosures of which are hereby incorporated by reference herein.

Similar to inflators, exhaust valves and relief valves are commonly installed onto inflatable articles by threading them into a manifold that mounted through the fabric of the article.

While manifold assemblies have been in extensive use in the industry for many years, they are specifically designed and configured for the particular inflator, exhaust valve or relief valve and are not interchangeable. Moreover, they are relatively expensive to manufacture and require additional assembly operations. Accordingly, there existed a need in the inflator industry for an inflator which obviates the need for manifold assemblies and the like.

Exteriorly-mounted inflators requiring a one-way valve either in the manifold or in the body of the heat-sealable inflator to permit inflation of the inflatable article while precluding deflation once inflated, appreciably increases the complexity of the inflator and the cost of manufacture. Further, exteriorly-mounted inflators are often covered by a flap to aesthetically conceal and protect the inflator from inadvertent snagging. Often, the flap includes a sewn-in clear window allowing the user to view the “status indicator” of the inflator to verify that it is in a fully-charged, ready condition (see generally U.S. Pat. No. 6,589,087, the disclosure of which is hereby incorporated by reference herein). Hence, there presently exists a need for a mounting system for inflators that eliminate the requirement for such one-way valves and to eliminate the use of flaps to conceal and protect the exteriorly-mounted inflators.

Therefore, it is an object of this invention to provide an improvement which overcomes the aforementioned inadequacies of the prior art devices and methods and provides an improvement which is a significant contribution to the advancement of the inflation art.

Another object of this invention is to provide a universal mounting system in which an inflator, exhaust valve or relief valve is positioned interiorly of the inflatable article.

Another object of this invention is to mount at least a portion of an inflator with its gas cartridge interiorly of the inflatable article such that the gas escaping from the gas cartridge upon firing flows directly into the inflatable article.

Another object of this invention is to allow removal of the inflator for routine periodic maintenance or after firing to be serviced with a new gas cartridge.

Another object of this invention is to provide a reversible exhaust valve/relief valve to function as an exhaust valve when positioned in one direction into the bore and to function as a relief valve when positioned in the reverse direction.

The foregoing has outlined some of the pertinent objects of the invention. These objects should be construed to be merely illustrative of some of the more prominent features and applications of the intended invention. Various embodiments of the invention may have none, some or all of these objects of the invention. Further, many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing this invention, this invention comprises an apparatus and method for mounting an inflator, exhaust valve or relief valve interiorly of an inflatable article. More particularly, this invention comprises an receiver having an integral mounting flange formed about its upper periphery that is heat sealed interiorly about an opening in the fabric of an inflatable article to be substantially flush with the contour of the inflatable article once inflated. The receiver comprises a generally circular cylindrical bore for removably receiving a corresponding generally circular cylindrical portion of the inflator, exhaust valve or relief valve therein. A locking key removably engages into corresponding detents in the mounting flange to removably secure the inflator, exhaust valve or relief valve in the bore. An O-ring is provided about the generally circular cylindrical portion of the inflator, exhaust valve or relief valve to form a seal with the bore and prevent any leakage of gas from the interior of the inflatable article.

In the case of the inflator, upon assembly, the inflator having an unspent gas cartridge installed, is inserted cartridge-first into the bore. Upon further insertion, the gas cartridge is fully positioned within the interior of the inflatable article and the circular cylindrical portion of the inflator is sealed within the circular cylindrical bore of the receiver by means of the O-ring. The inflator is then securely latched in position in the receiver by the locking key. Upon actuation of the inflator, either manually via a tethered jerk handle or automatically via an automatic actuator, the frangible seal of the gas cartridge is pierced whereupon the gas escapes therefrom directly into the inflatable article to inflate the same. After use, the inflator may be conveniently removed from the receiver by removing the locking key and pulling the inflator out from within the receiver, whereon the spent gas cartridge may be replaced and, in the case of an automatic inflator employing an automatic actuator, the actuator may be appropriately serviced by removing its bobbin and installing a new one. The fully-charged inflator may then be reinstalled into the receiver and locked into position by the locking key, ready for subsequent use.

It should be appreciated that by positioning the gas cartridge interiorly of the inflatable article, the gas escaping from the gas cartridge upon firing merely flows directly into the inflatable article. The requirement for one-way valves as commonly used in prior art inflators referenced above, is therefore eliminated. Moreover, it should also be appreciated that by positioning the gas cartridge interiorly of the inflatable article, the inflator is substantially flush with the exterior of the inflatable article and therefore presents a considerably improved aesthetic appearance. The prior art use of flaps to cover exterior-mounted inflators to minimize snagging, may therefore be eliminated.

In the case of the exhaust valve or relief valve, the valve seat mechanism is mounted into a housing whose outer diameter of the housing is configured to fit into the receiver, sealed with an O-ring and locked into position by the locking key. Preferably, the exposed end of the housing is grated to allow airflow therethrough but remains substantially flush with the curvature of the receiver when installed. Also preferably, in the case of an exhaust valve, an rod extends from the flush surface of the housing to engage the actuator of the exhaust valve allowing an operator to manually exhaust the inflatable article by pushing on the rod to open the exhaust valve. Finally, the most-preferred embodiment of the exhaust and relief valve mechanism comprises a reversible design that functions as an exhaust valve when installed one way into the housing and as a relief valve when installed 180 degrees in the reverse direction in the housing.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a perspective view of the universal receiver for receiving an inflator;

FIG. 1A is a perspective view of the elongated universal receiver having an elongated configuration for encompassing the gas cartridge of the inflator and for heat sealing to the interior of the inflatable article along its length;

FIG. 2 is a top perspective view of FIG. 1 showing the universal receiver mounted to the fabric of an inflatable article;

FIG. 3 is a bottom perspective view of FIG. 2;

FIG. 4 is a top perspective view of the universal receiver;

FIG. 5 is a bottom perspective view of the universal receiver adapted for receiving an annular ring;

FIG. 5A is a bottom perspective view of the universal receiver;

FIG. 5B is a bottom perspective view of the elongated universal receiver;

FIG. 6 is a front view of the universal receiver showing the keyways;

FIG. 7 is a top view of the universal receiver showing the slots for receiving the locking key;

FIGS. 8, 8A and 8B are bottom views of the three embodiments of the universal receiver;

FIGS. 9 and 9A are right side views of the universal receiver, the left side views being a mirror image thereof;

FIGS. 10, 10A and 10B are rear end views of the universal receiver;

FIG. 11 is a perspective view of the locking key;

FIG. 12 is a top perspective view of the universal receiver mounted about a hole in the fabric of an inflatable device;

FIG. 13 is bottom perspective view of FIG. 12;

FIG. 14 is a side view of the inflator;

FIG. 15 is a top view of the inflator;

FIG. 16 is a front perspective view of the housing with an exhaust valve mounted therein;

FIG. 17 is a rear perspective view of FIG. 16;

FIG. 18 is rear perspective view of a relief valve mounted within the housing;

FIG. 19 front perspective view of the housing mounted within the universal receiver; and

FIG. 20 is a rear perspective view (inverted) of the housing mounted within the universal receiver.

Similar reference characters refer to similar parts throughout the several views of the drawings.

### DETAILED DESCRIPTION OF THE PREFERRED EMBODIMENT

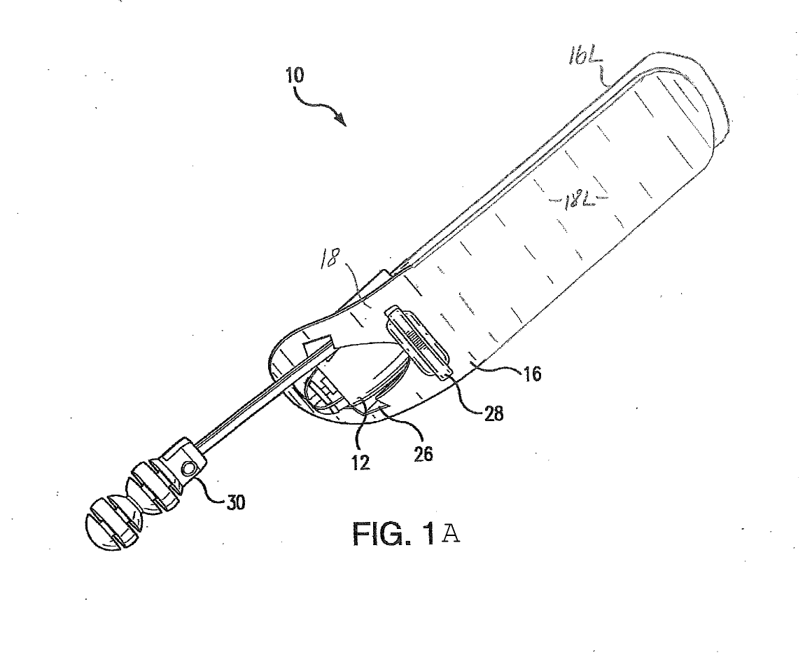

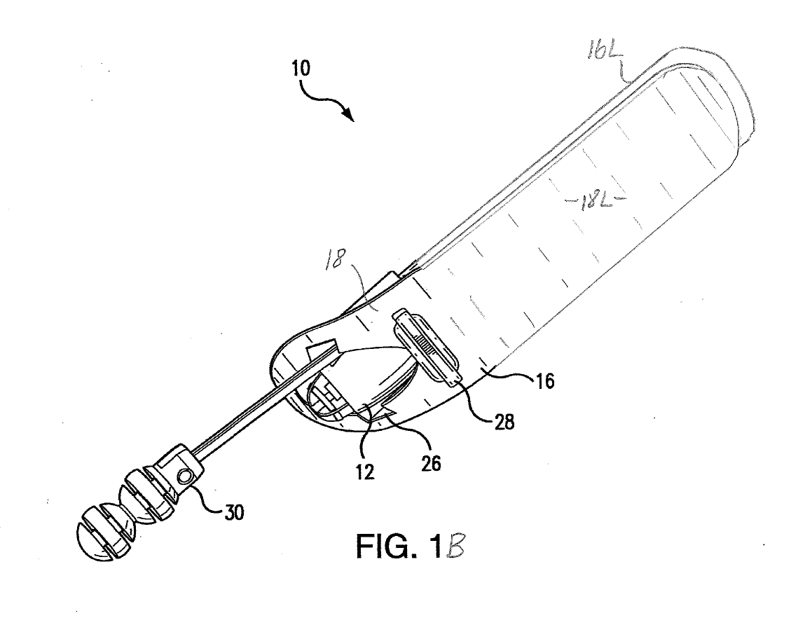

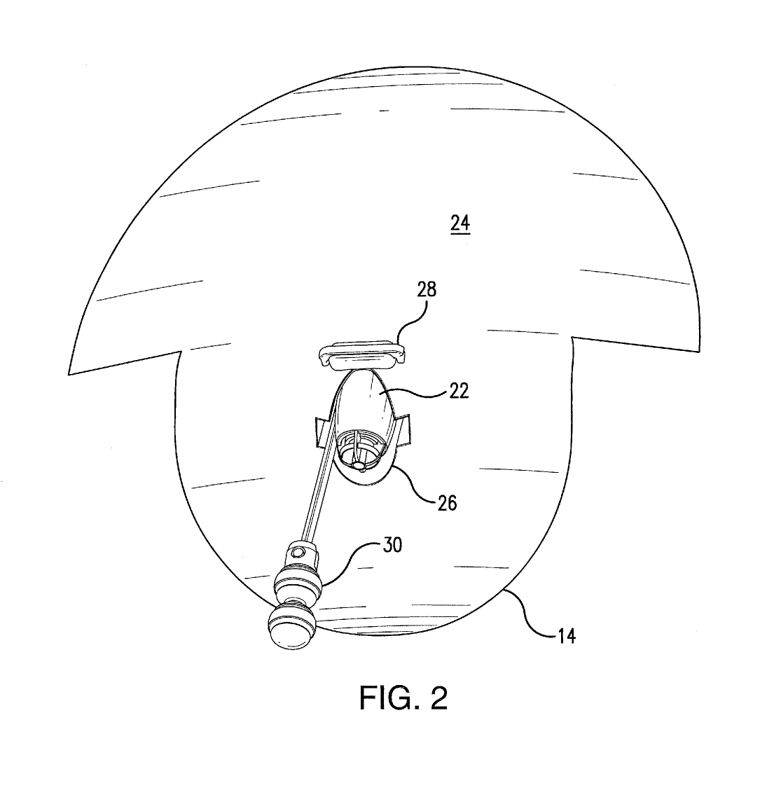

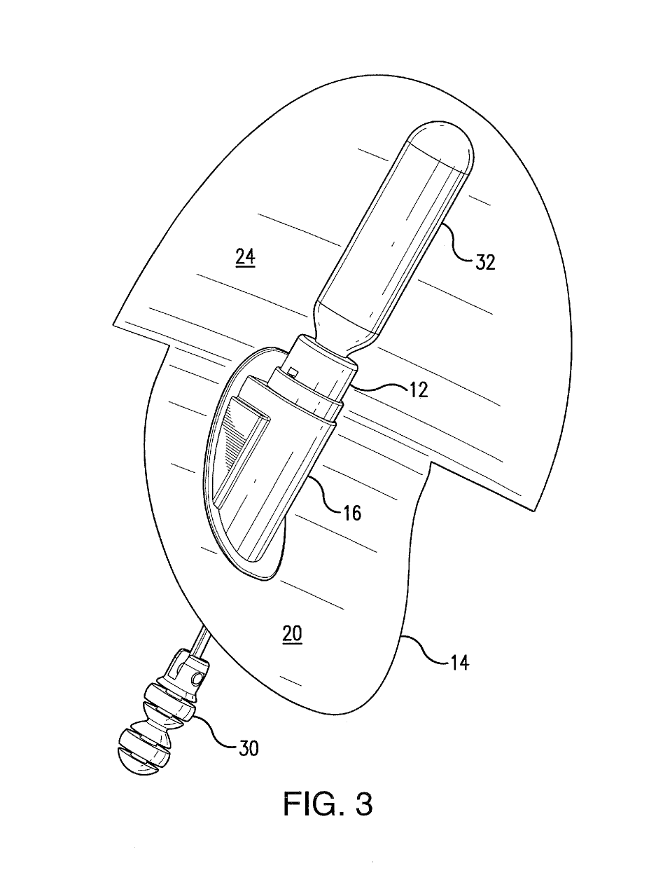

Referring to FIGS. 1-3, the apparatus and method of the invention 10 comprises a universal receiver 16 for mounting an inflator 12 (or exhaust valve or relief valve discussed below in relation to FIGS. 16-20) interiorly of an inflatable article 14. The inflator receiver 16 comprises a peripheral integral mounting flange 18 that is heat-sealed onto the interior surface 20 of a hole 22 in the fabric 24 of the inflatable article 14. The inflator receiver 16 further comprises a longitudinal central bore 26, preferably circular cylindrical, for removably receiving the inflator 12 (or exhaust valve or relief valve discussed below) that is correspondingly also preferably circular cylindrical to slide into the inflator receiver 16. A removable locking key 28 removably locks the inflator 12 (or exhaust valve or relief valve discussed below) into the receiver 16.

Once installed in the receiver 16, the inflator's 12 tethered jerk handle 30 extends exteriorly of the inflatable article 14 for easy grasping by a user of the inflatable article 14 allowing manual actuation of the inflator 12, whereupon a pierce pin (not shown) pierces the frangible seal of a gas cartridge 32 allowing the gas escaping therefrom to flow into the interior of the inflatable article 14 to inflate the same. Correspondingly, once installed in the receiver 16, the inflator's 12 automatic actuator 34 is exposed to the exterior of the inflatable article 14 allowing it to become wetted upon immersion in water to automatically actuate the pierce pin to pierce the frangible seal of the gas cartridge 32 whereupon the escaping gas flows into the interior of the inflatable article 14 to inflate the same.

The locking key 28 may be removed allowing the inflator 12 to be removed from within the receiver 16 for servicing. Specifically, once the inflator 12 is removed, the now-spent gas cartridge 32 may be removed and a new one installed. Likewise, if the inflator 12 comprises an automatic actuator 32, its now-spent bobbin may be removed and a new one installed. Once the inflator 12 is serviced, it may be reinstalled into the receiver 16 by inserting the gas cartridge 32 into the receiver 16 and pushing the inflator 12 in to the appropriate depth whereon the locking key 28 is reinserted to lock the inflator 12 into position.

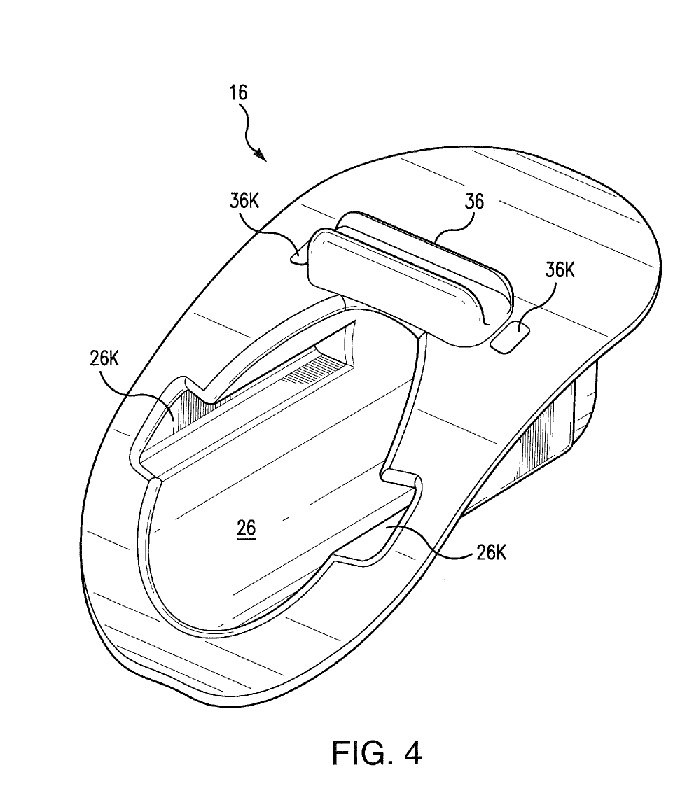

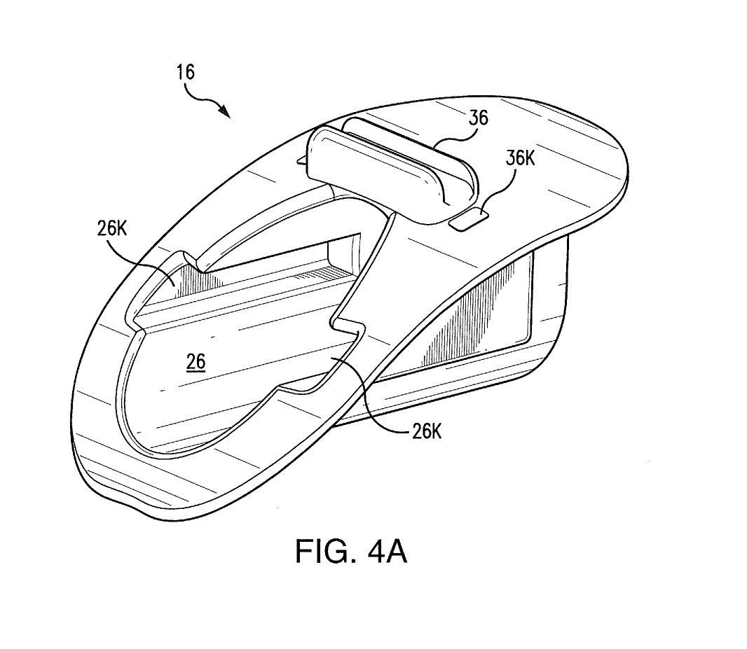

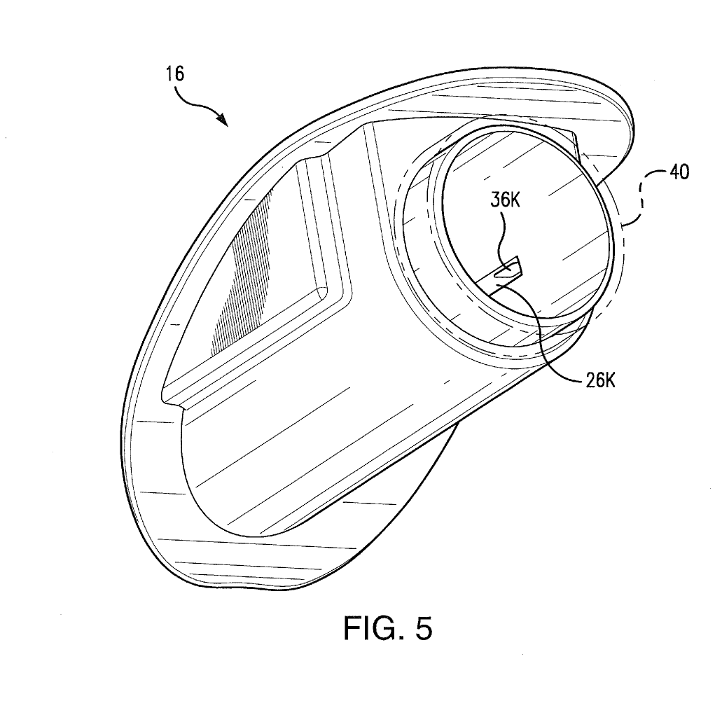

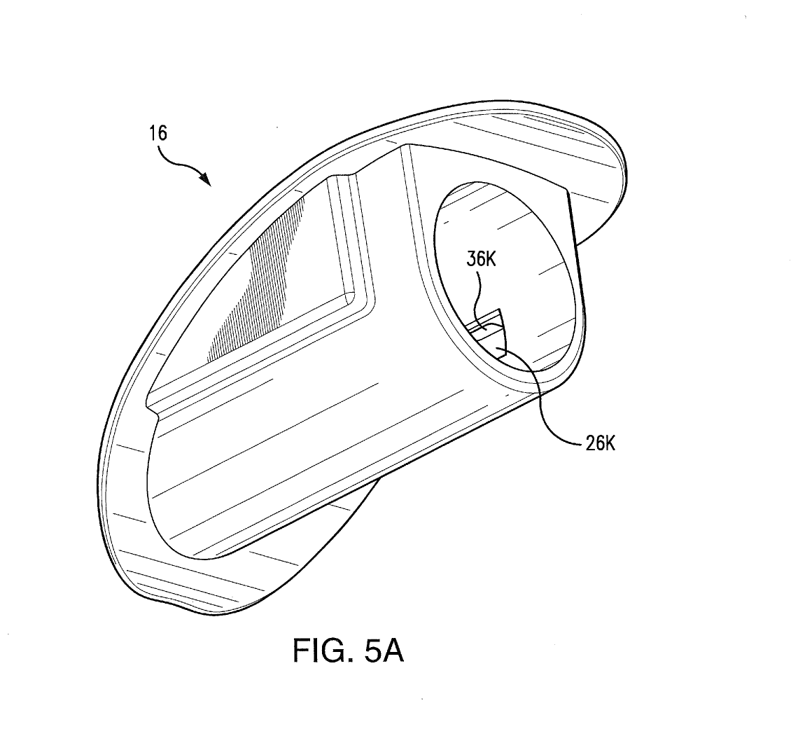

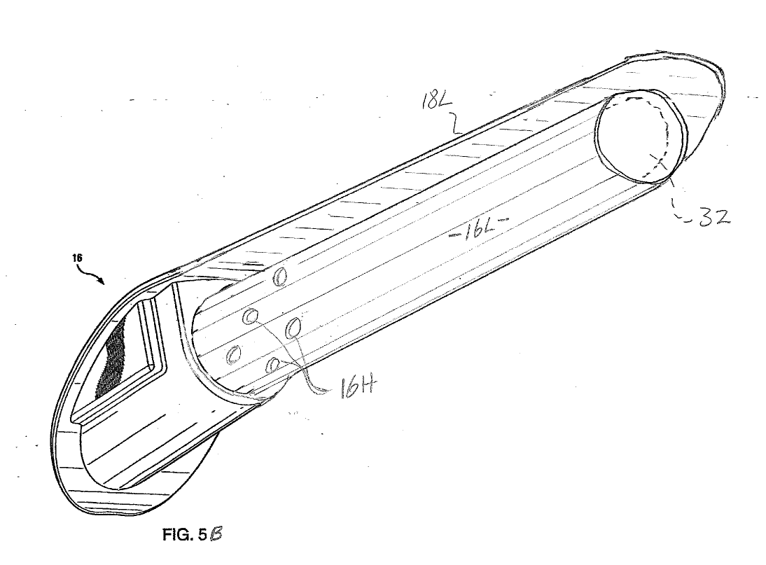

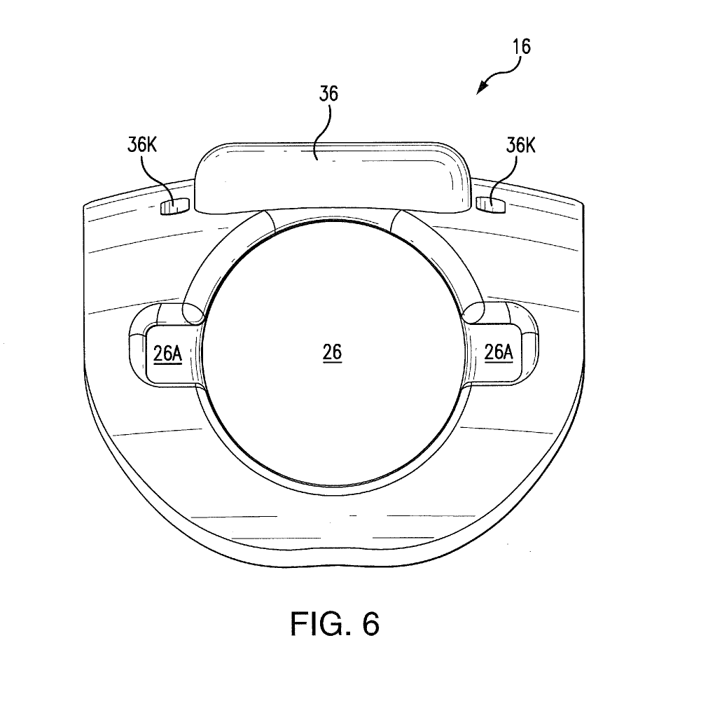

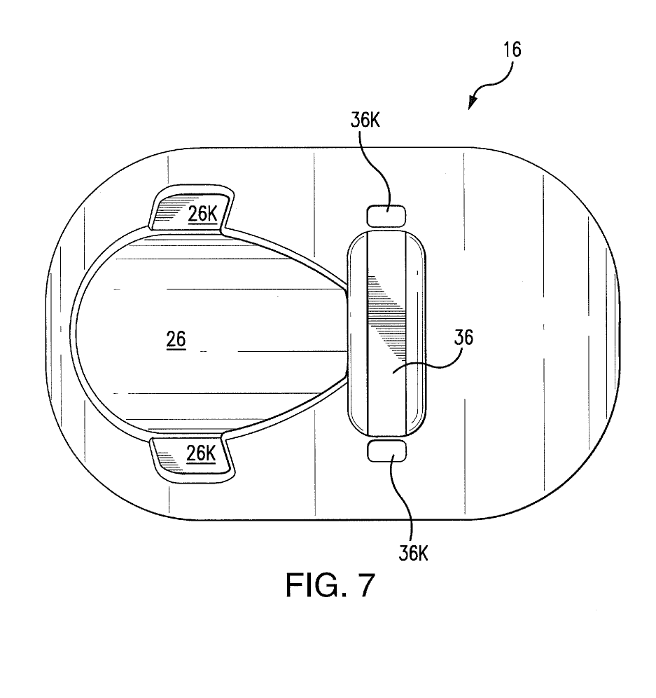

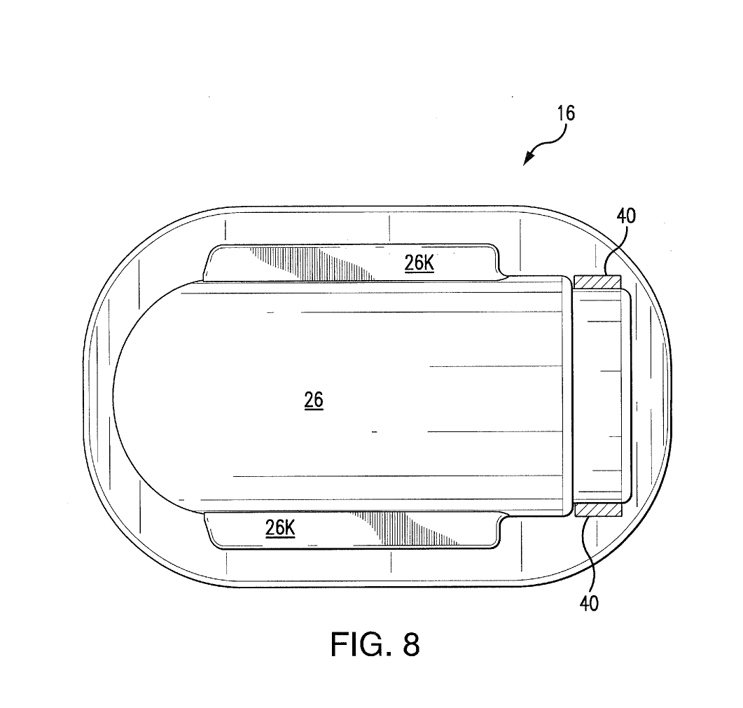

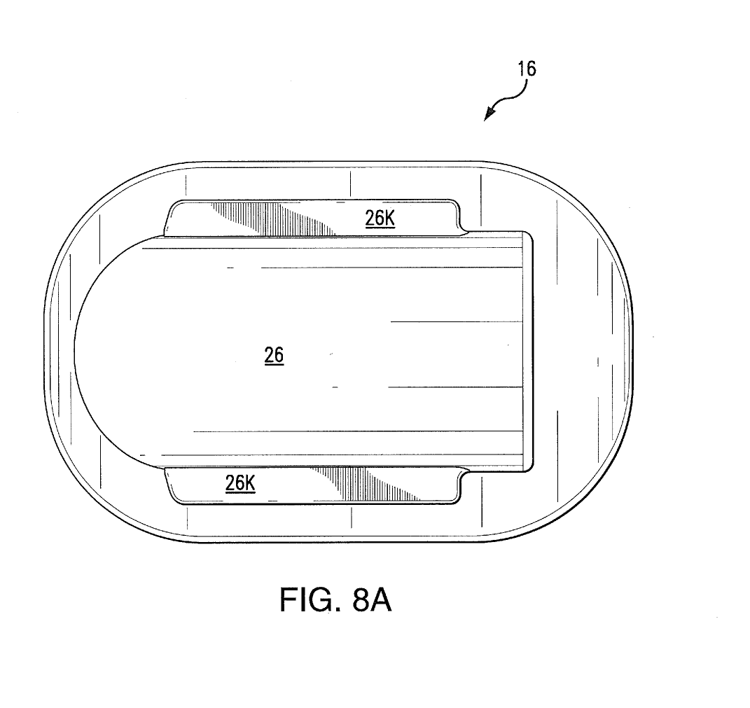

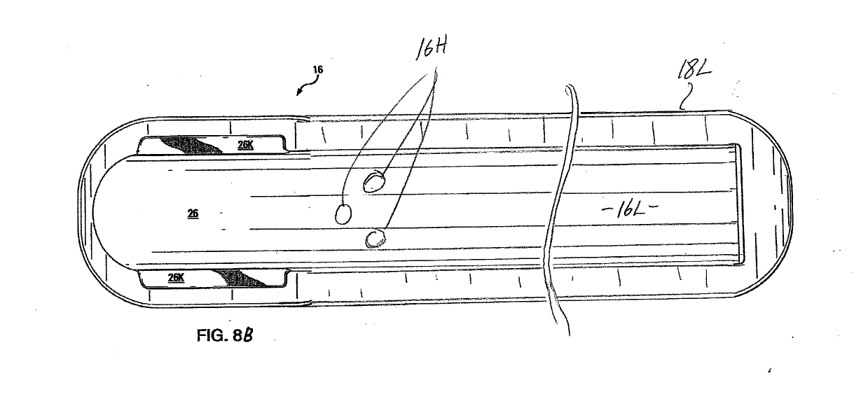

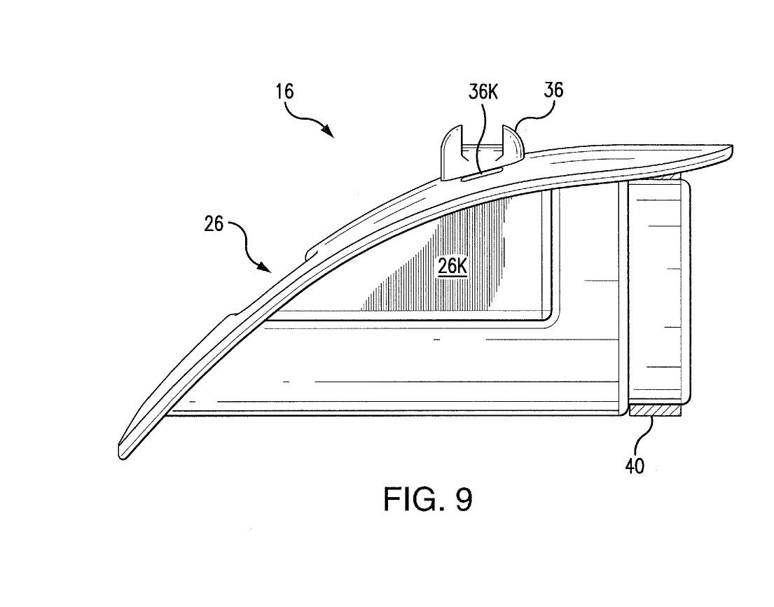

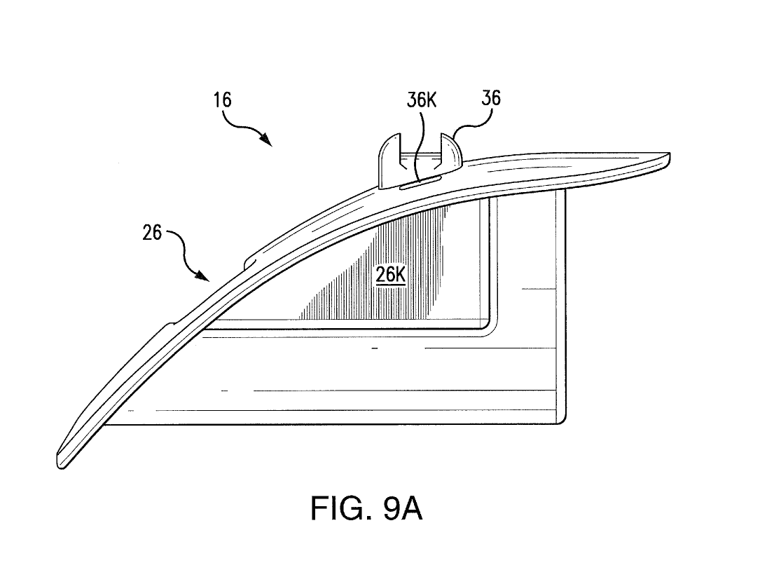

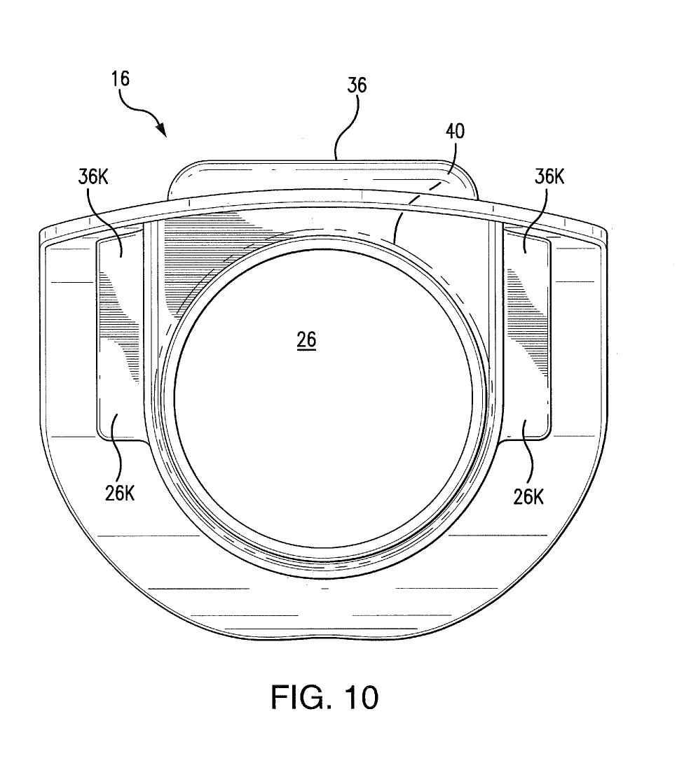

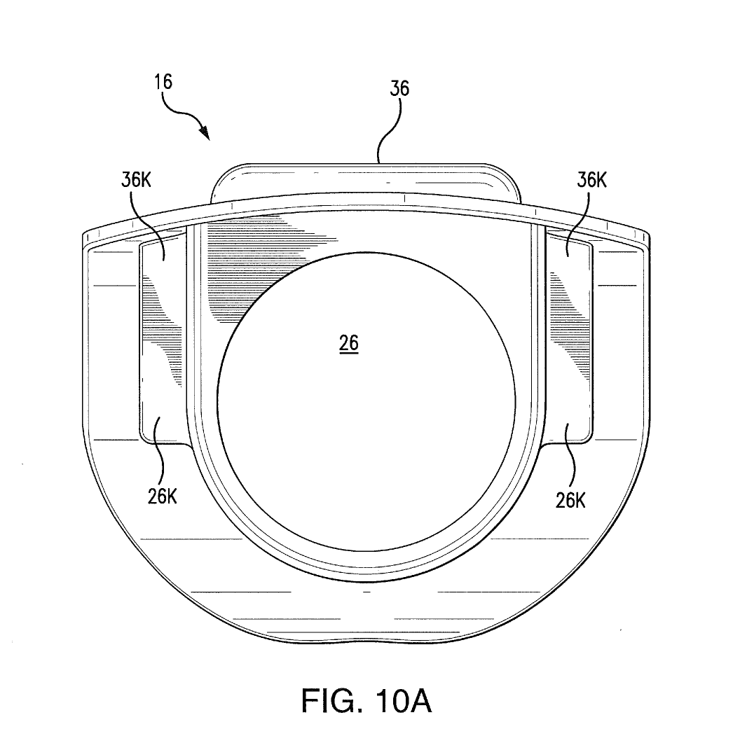

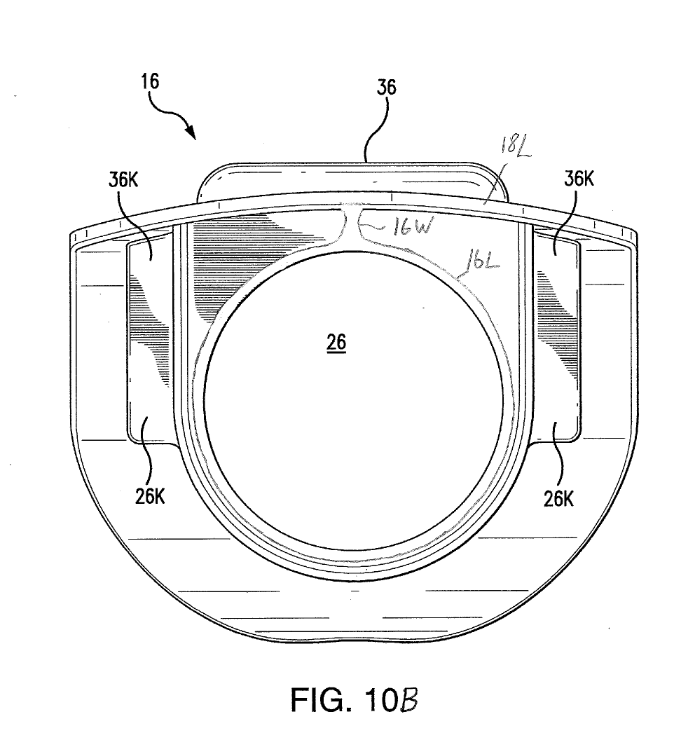

Referring to FIGS. 4-10, the receiver 16 of the invention comprises a generally circular cylindrical body 38 through which is formed the bore 26 for receiving the inflator 12. The receiver 16 is preferably injected molded of a heat-sealable material that may be heat sealed to the fabric 24 of the inflatable article 14.

FIGS. 4-10 show one embodiment of the receiver 16 whereas the same figures suffixed with the letter A shown another embodiment. In the one embodiment, the interior end of the body 38 about the bore 26 comprises a reduced diameter portion 38R onto which is mounted an annular ring 40 composed of a hard plastic or a metal to provide rigidity to the bore 26 and assure an airtight seal with the inflator 12 (as further described below). However, in the event the receiver 16 is injected molded of a sufficiently rigid material, the reduced-diameter portion 38R and ring 40 may be eliminated as more particularly shown in the other embodiment of the receiver 16 in FIGS. 4A-10A.

In either embodiment of the receiver 16 shown in FIGS. 4-10, the receiver 16 comprises a pair of blind keyways 26K extending inwardly on diametrically opposing sides of the bore 26. The depth of the keyways 26K determines the depth by which the inflator 12 is inserted into the receiver 16 for locking into position by the locking key 28 (as further described below).

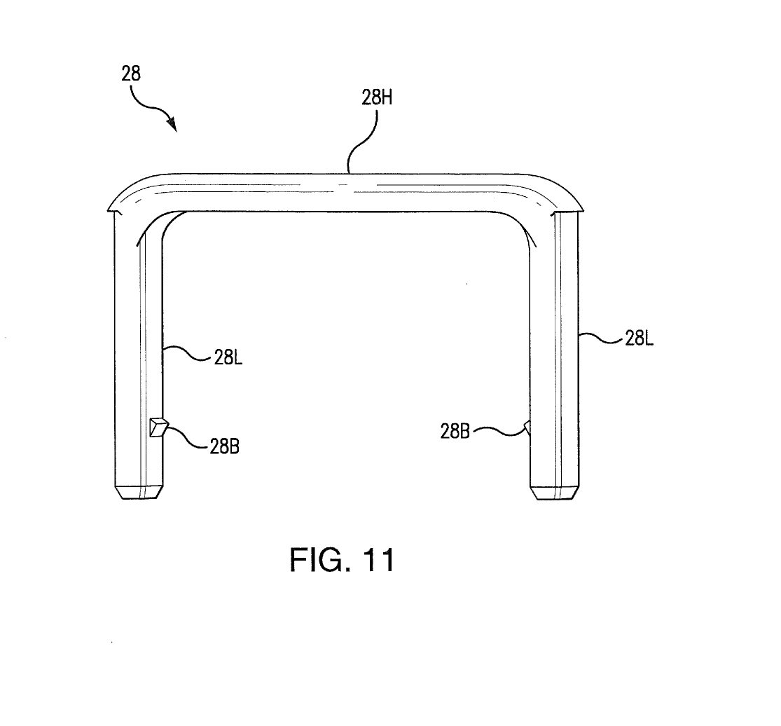

A locking key mount 36 is positioned above the bore 26 flanked by two locking keyways 36K that extend into the receiver to intercept the bore keyways 26. As shown in FIG. 11, the locking key 28 comprises a horizontal portion 28H and two depending legs 28L that respectively engage into the locking keyways 36K. The depending legs 28L are dimensioned to extend into the bore keyways 26K to the bottom thereof when the horizontal portion 28H is seated onto the mount 36. Preferably, the locking key is further dimensioned to fit snugly into position such that an appreciable force is required to install or remove it. Optionally, a barb 28B may be provided on the inside of the legs 28L to engage into the bore keyways 26K to achieve a “snap-fit”, preferably necessitating a tool for removal.

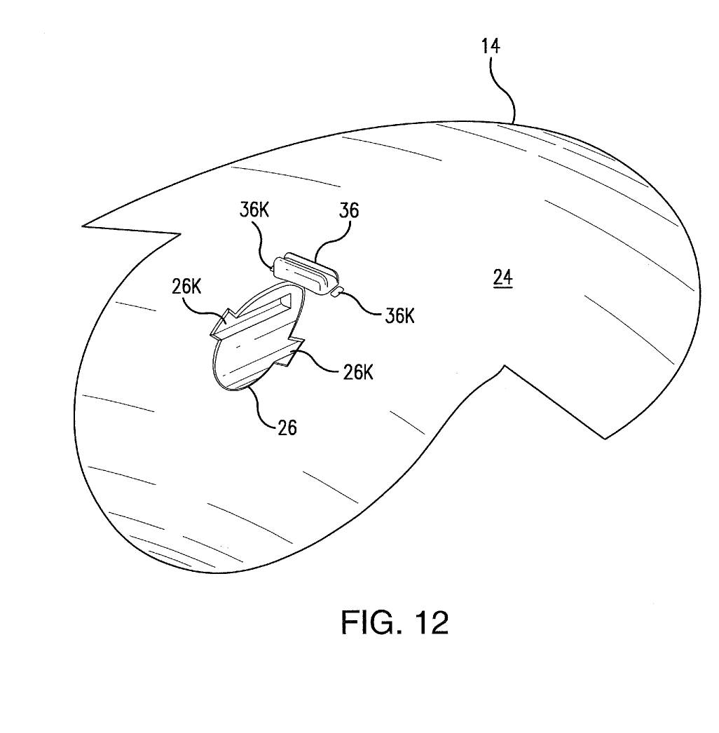

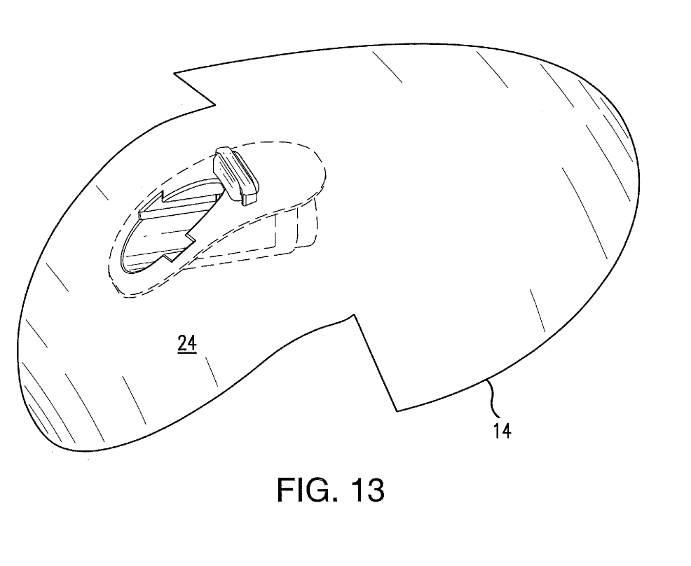

As shown in FIGS. 12 and 13, the hole 22 in the fabric 24 of the inflatable article 14 may comprise a configuration the matches the configuration of the components of the receiver 16 that are intended to remain exposed; namely, the bore 26 and its keyways 26K into which the inflator 12 is inserted and the locking key mount 36 and its keyways 36K into which the locking key 28 is inserted, while covering the mounting flange 18 of the receiver 16 that is heat-sealed interiorly of the inflatable article 14 about the periphery of the hole 22.

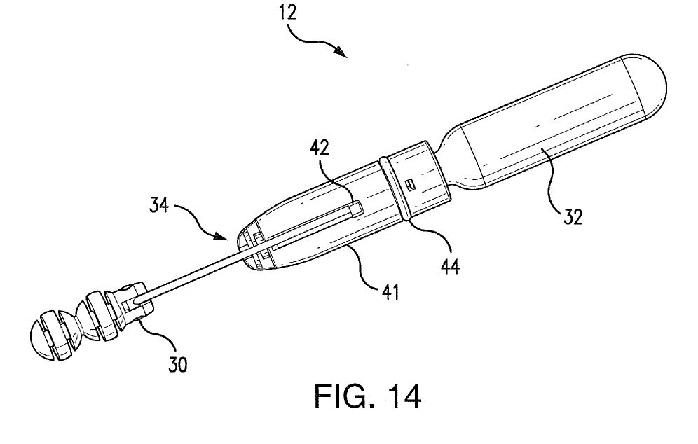

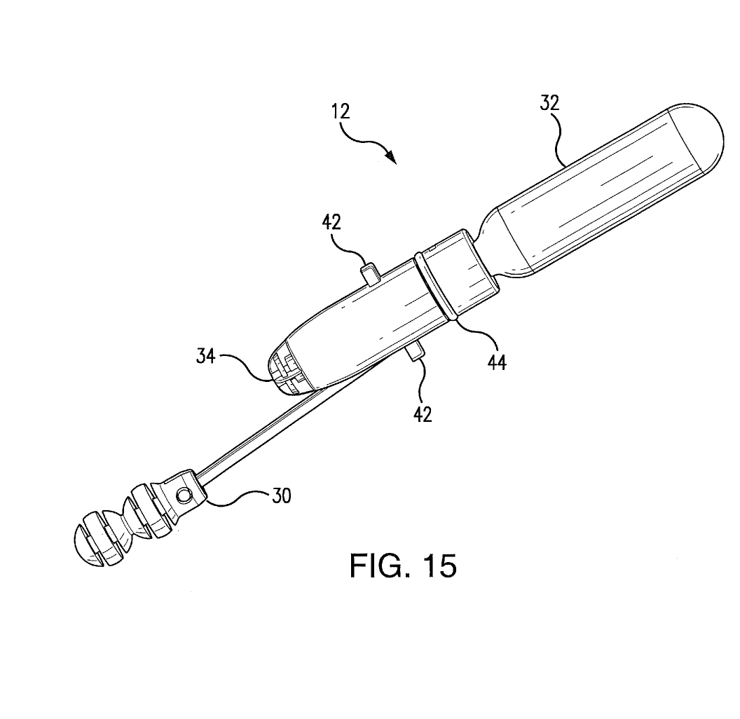

Inasmuch as the subject invention employs the universal receiver 16, it should be appreciated that the specific mechanics of the manually-operated or automatically-operated inflator 12 of the subject invention may, without departing from the spirit and scope of this invention, comprise various prior art devices such as ones similar to those described above. However, as shown in FIGS. 14 and 15, the automatic inflator 12 preferably comprises a generally circular cylindrical body 41 having diametrically opposing protrusions 42 dimensioned to slide into the diametrically opposing keyways 26K of the bore 26 as the inflator 12 in inserted gas-cylinder-first, into the bore 26. The inflator 12 is slid into the bore 26 until the protrusions 42 bottom out at the blind end of the keyways 26K. The inflator 12 is locked into position upon insertion of the legs 28L of the locking key 28 into the locking keyways 36K because the legs 28L are positioned in front of the protrusions 42 once the legs 28L bottom out in the keyways 26K. Finally, an O-ring 44 is provided about the inflator body 41 proximate to form an airtight seal with the lumen of the bore 26.

As shown in FIGS. 1A, 5B, 8B and 9B, the receiver 16 may alternatively comprise an elongated configuration having an elongated flange 18L and an elongated receiver 16L that encompasses the gas cartridge 32. The elongated flange 18L and the elongated receiver 161 are joined together by web 16W. Preferably, the elongated flange 18L is heat-sealed along all or a substantial portion of its length onto the interior surface 20 of a hole 22 in the fabric 24 of the inflatable article 14 and the elongated receiver 16L fully or at least partially encompasses the gas cartridge 32. The purpose of the elongated flange 18L and the elongated receiver 16L is to prevent the gas cartridge 32 from otherwise sliding side-to-side and rubbing against the interior surface of the fabric 24 of the inflatable article 14 and potentially rubbing a hole in the fabric 24. It is noted that the end of the elongated receiver 16L may be opened to allow gas escaping from the gas cartridge 32 to flow into the inflatable article 14 to inflate the same. It is also noted that additional vent holes 16H may be provided along the length of the elongated receiver 16L to provide additional paths for the escaping air from the gas cartridge 32 to flow into the inflatable article 14 to inflate the same.

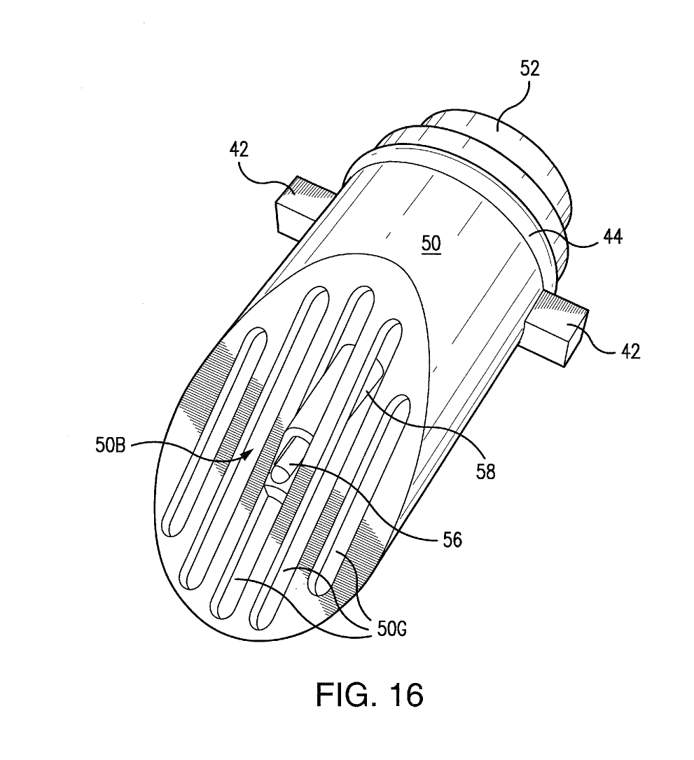

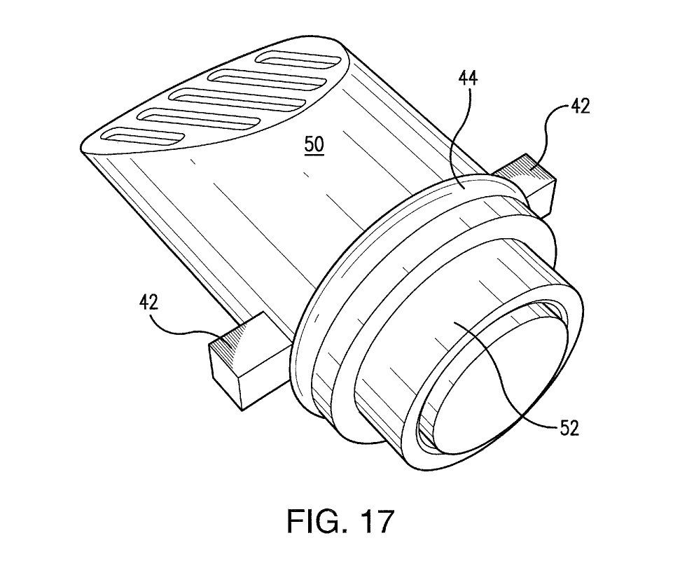

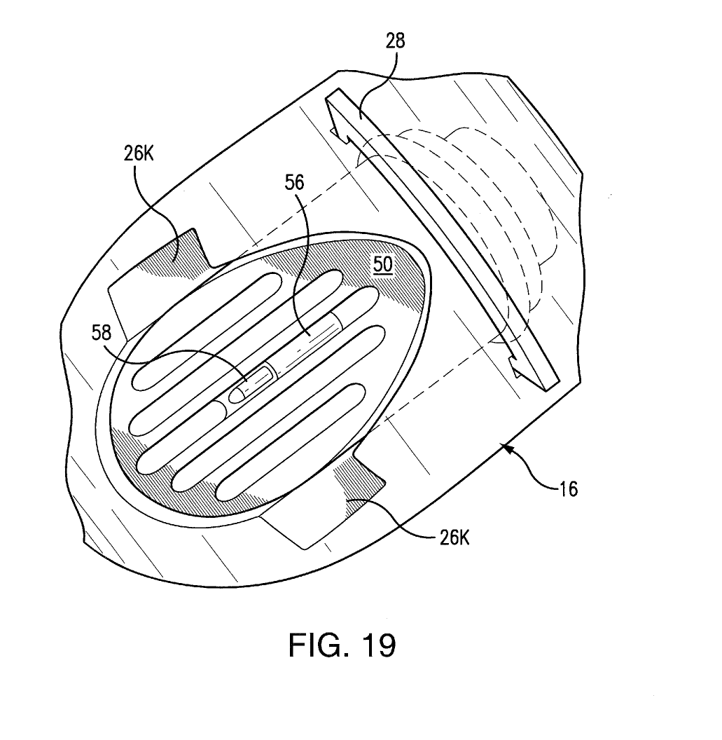

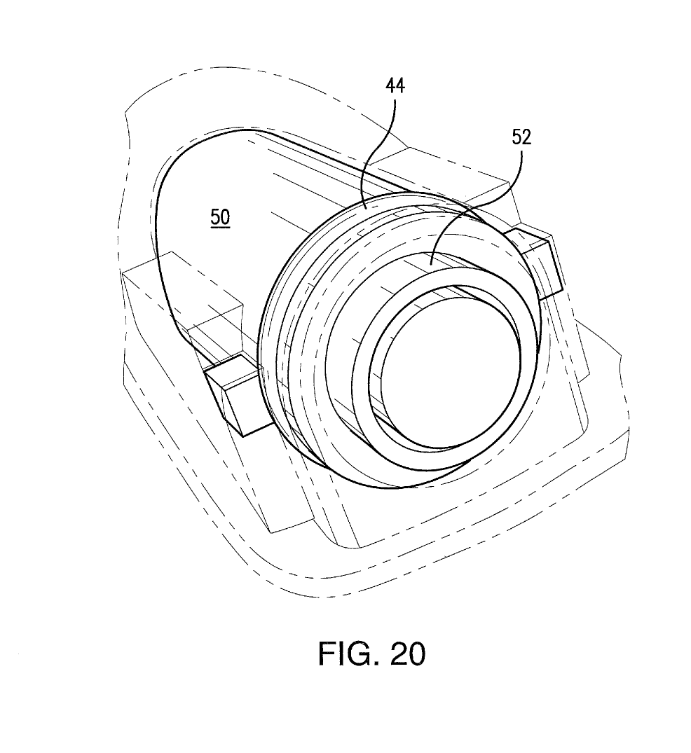

Referring now to FIGS. 16-20, the universal receiver 16 of the invention may also function as a receiver for a housing 50 containing an exhaust valve 52 or a relief valve 54. More particularly, as best shown in FIGS. 16 and 17, housing 50 comprises a circular cylindrical configuration having the diametrically-opposing protrusions 42 extending therefrom for slidable engagement into the keyways 26K of the bore 26 to be locked into position by the locking key 28 (see FIGS. 19 and 20) in the same manner as previously described above in connection with the inflator 12. An O-ring 44 is provided about the circumference of the housing 50 to form an airtight seal with the bore 26.

The housing 50 comprises a front grate 50G allowing airflow into a central bore 50B. The rear end of the central bore 50B is dimensioned to receive the exhaust valve 52 or relief valve 54. In the case of the exhaust valve 52, a push rod 56 slidably positioned into a guide tube 58 extends from the grate 50G to the actuator of the exhaust valve 52 allowing a user to manually actuate the exhaust valve 52 to dump air from the inflatable article 14 by depressing on the push rod 56.

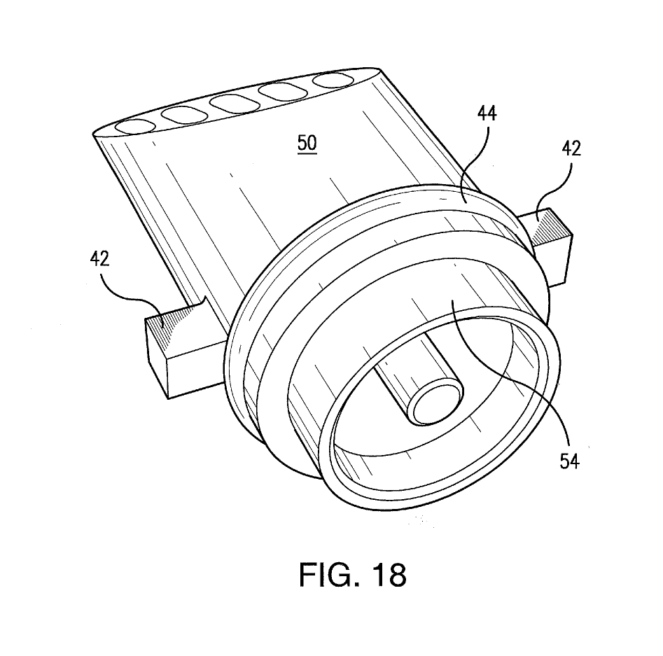

The exhaust valve 52 and relief valve 54 may be configured to be “reversible” such that when positioned in one direction into the bore 50B (see FIG. 17), it functions as an exhaust valve 52 (operable by push rod 56) and when positioned in the 180 degree opposite direction (see FIG. 18), it functions as a relief valve 54.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A receiver assembly for mounting an inflator, exhaust valve or relief valve interiorly of an inflatable article, comprising in combination:
a receiver having an integral mounting flange formed about its upper periphery adapted to be heat sealed about an opening in the fabric of the inflatable article, said receiver comprising a bore for receiving a corresponding portion of the inflator, exhaust valve or relief valve therein; and
a locking key engaging said mounting flange to secure the inflator, exhaust valve or relief valve in said bore.

2. The receiver assembly as set forth in claim 1, wherein said receiver comprises an extended receiver to fully encompass the inflator, exhaust valve or relief valve.

3. The receiver assembly as set forth in claim 1, wherein said locking key is removable allowing removal of the inflator, exhaust valve or relief valve.

4. The receiver assembly as set forth in claim 1, wherein said exhaust valve and relief valve are reversible to function as an exhaust valve when positioned in one direction into said bore and to function as a relief valve when positioned in the reverse direction.

5. A method for mounting an inflator, exhaust valve or relief valve interiorly of an inflatable article, comprising the steps of:
mounting a receiver 16 interiorly of the an inflatable article, the receiver comprising a peripheral integral mounting flange that is heat-sealed onto an interior surface of a hole in the inflatable article, the inflator receiver further comprising a longitudinal central bore for removably receiving the inflator, exhaust valve or relief valve; and
locking the inflator, exhaust valve or relief valve into the receiver.

6. The method as set forth in claim 5, wherein the locking key is removable to allow removal of the inflator, exhaust valve or relief valve.

7. The method as set forth in claim 5, further including the step of sealing the inflator, exhaust valve or relief valve in the bore by an O-ring positioned about said portion of the inflator, exhaust valve or relief valve to form a seal with the bore.

8. The method as set forth in claim 5, further including the step of removing the locking key allowing removal of the inflator, exhaust valve or relief valve from the bore.

9. The method as set forth in claim 8, further including the step of reversing the direction of the exhaust valve or relief valve to function as an exhaust valve when positioned in one direction into the bore and to function as a relief valve when positioned in the reverse direction.

10. The method as set forth in claim 5, further including the step of extending the length of the receiver to encompass the inflator.

11. A receiver assembly for mounting an inflator interiorly of an inflatable article, comprising in combination:
a receiver for mounting the inflator interiorly of the inflatable article, the receiver comprising a peripheral integral mounting flange that is adapted to be sealed onto an interior surface of a hole in the inflatable article and a longitudinal central bore for removably receiving the inflator; and
a locking key for locking the inflator into said bore of said receiver,
whereby once installed in said receiver, the inflator's tethered jerk handle extends exteriorly of the inflatable article for easy grasping by a user of the inflatable article allowing manual actuation of the inflator, whereupon a pierce pin of the inflator pierces a frangible seal of the inflator's gas cartridge allowing the gas escaping therefrom to flow into the interior of the inflatable article to inflate the same.

12. The receiver assembly as set forth in claim 11, wherein the inflator comprises an automatic inflator and wherein said receiver is adapted to expose the automatic inflator to the exterior of the inflatable article allowing it to become wetted upon immersion in water to automatically actuate the pierce pin to pierce the frangible seal of the gas cartridge, whereupon the escaping gas flows into the interior of the inflatable article to inflate the same.

13. The receiver assembly as set forth in claim 11, wherein said locking key is removable allowing the inflator to be removed from within said bore of said receiver for servicing and then reinstalled.

14. The receiver assembly as set forth in claim 11, wherein said bore comprises a generally circular cylindrical configuration for receiving a correspondingly circular cylindrical inflator.

15. The receiver assembly as set forth in claim 11, wherein said flange comprises a heat-sealable material that may be heat sealed to the inflatable article.

16. The receiver assembly as set forth in claim 11, wherein said bore comprises a reduced diameter portion onto which is mounted an annular ring composed of a hard material to provide rigidity to said bore and assure an airtight seal with the inflator.

17. The receiver assembly as set forth in claim 11, wherein said receiver comprises a pair of blind keyways extending inwardly on opposing sides of said bore to receive corresponding opposing protrusions extending from the inflator, the depth of which determines the depth by which the inflator may be inserted into said bore of the receiver and locked into position by said locking key.

18. The receiver assembly as set forth in claim 11, wherein said locking key comprises a horizontal portion and two depending legs and wherein said receiver assembly further includes a locking key mount positioned above said bore on which said horizontal portion is seated and opposing locking keyways that extend into said receiver to intercept opposing bore keyways in which said depending legs are inserted to extend into the bore keyways to secure the inflator in said bore.

19. The receiver assembly as set forth in claim 11, wherein at least one of said legs of said locking key further comprises a barb to engage into at least one of said bore keyways to achieve a “snap-fit.”

20. The receiver assembly as set forth in claim 11, wherein said receiver comprises an elongated configuration to encompass the inflator and wherein said flange comprises an elongated configuration that is sealed along its length to the interior of the inflatable article.
